(19) United States
(12) Patent Application Publication
(10) Pub. No.: US 2026/0316698 A1
(43) Pub. Date: Oct. 15, 2026

(54) AUTOMOTIVE MULTILAYER TRIM PART WITH AN ELASTOMERIC LAYER

(71) Applicant: AUTONEUM MANAGEMENT AG, Winterthur (CH)

(72) Inventor: Yann BERGER, Aadorf (CH)

(73) Assignee: AUTONEUM MANAGEMENT AG, Winterthur (CH)

(21) Appl. No.: 19/485,964

(22) PCT Filed: May 13, 2024
(86) PCT No.: PCT/EP2024/063035

§ 371 Date: Nov. 19, 2025

(30) Foreign Application Priority Data
May 22, 2023 (EP) 23174537.3

(51) Int. Cl. B60R 13/02; C08K 3/26; C08K 3/30; C08L 23/16; D06N 7/00

(52) U.S. Cl. CPC B60R 13/0256; C08K 3/26; C08K 3/30; C08L 23/16; D06N 7/0068; C08K 2003/265; C08K 2003/3045; D06N 2201/10; D06N 2203/042; D06N 2211/00

(57) ABSTRACT

Multilayer trim part for a vehicle comprising at least a first layer and an elastomeric layer adjacent to and laminated surface to surface to the first layer, and whereby the elastomeric layer comprises a thermoplastic polyolefin elastomer, an inorganic filler, and a fatty acid. Whereby the elastomeric layer further comprises a maleic-anhydride grafted polypropylene (MAgPP).

This application is a national stage application under 35 U.S.C. 371 and claims the benefit of PCT Application No. PCT/EP2024/063035 having an international filing date of May 13, 2024, which designated the United States, which PCT application claimed the benefit of European Patent Application No. 23174537.3, filed May 22, 2023, the disclosure of each of which are incorporated by reference herein.

### TECHNICAL FIELD

The present invention is directed to automotive multilayer trim parts with a elastomeric layer.

### BACKGROUND ART

In the field of automotive design, trim parts play a pivotal role in providing comfort, insulation, and noise reduction, as well as contributing to overall appearance and tactile experience within the vehicle's interior. So called “Mass layers” are used in trim parts to optimize mechanical and acoustic performance by providing for instance abrasion resistance, stiffness or weight to trim parts such as carpets. They typically exhibit high area weights between 1 kg/m² and 5 kg/m² when used in a mass-spring acoustic system for improved noise, vibration, and harshness (NVH) characteristics. If there is not a high acoustic insulating needs but more a need on mechanical performance also low area weights may be used as mass layer.

Mass layers, whether high or low area weight, may comprise filled polyolefin elastomers, as known in the art. However, the use of such olefin-based elastomeric materials may cause bonding issues with adjoining layers when good surface-to-surface lamination is required. Conventionally, this problem is addressed by incorporating additional adhesive or foil layer or layers to enhance the bond between the elastomeric layer and the adjacent layer or layers. However, this approach complicates the change of the stacked layers, whereby each material change of the adjacent layer necessitates the development of a distinct solution for the lamination to pair both with the adjacent layer and the elastomeric layer. The material of the elastomeric layer is such that not many materials bind easily to the surface of the elastomeric material without aid.

In the realm of trim parts, these adjacent layers may be fibrous layers, films or foam layers. For instance, an acoustic trim part for acoustic insulation, may comprise a combination of fibrous and/or foam layers next to the mass layer.

The laminating issues not only occur on initial lamination but may also cause a failure later during the use of the part. Trim parts placed in an automotive environment like the passenger compartment are subject to climatic temperature cycles during the use of the vehicle. Therefore, trim parts undergo a thermal aging test to simulate extreme continuous temperature changes. After cycles of climate aging, such shortcomings become evident through peeling tests, where the bond between the layers might not meet performance requirements. Furthermore, the melting temperature of the elastomeric layer is such that it sometimes fails during extreme temperature variations, degrading the integrity of the trim parts.

It is the object of the invention to overcome the problems of the prior art elastomeric material, in particular to provide an elastomeric layer that is better in adhesion even under climatic changes in an automotive environment.

### SUMMARY OF INVENTION

The problem is solved by a multilayer trim part for a vehicle comprising at least a first layer and an elastomeric layer adjacent and laminated surface to surface to the first layer, and whereby the elastomeric layer comprises a thermoplastic polyolefin elastomer, an inorganic filler, a fatty acid according to the main claim.

In particular, by the addition of a maleic-anhydride grafted polypropylene (MAgPP) into the material forming the elastomeric layer, not only the peeling force of the laminate formed by the elastomeric layer with adjacent layers could be increased. Surprisingly, the need for additional adhesive or foil layers to laminate adjacent layers to the elastomeric layer could be reduced or even eliminated.

The maleic anhydride moieties in the MAgPP may effectively bridge the interface between the material of the elastomeric layer being non-polar and substantially comprising polymers with a low surface energy, and the adjacent layer being polar and substantially comprising polymers with higher surface energy. The weak interfacial interactions between the two dissimilar materials would result in poor adhesion. Surprisingly, already the addition of low amounts of MAgPP increases the lamination between the adjacent layer and the elastomeric layer.

By varying the amount of MAgPP it is possible to further optimize the performance of the elastomeric layer in particular related to lamination of the elastomeric layer to adjacent layers without interfering with the requirements of the layer itself, like elongation, tensile strength for instance. Preferably the MAgPP comprised in the elastomeric layer may be between 5 and 30% by weight of the elastomeric layer.

In order to maintain processability when adding MAgPP, preferably the MAgPP itself has a low melt viscosity, between 2000 and 30000 mpa·s, preferably between 10000 and 25000 mpa·s using the Brookfield method at 190 °C (DIN 53019). The choice of the viscosity is dependent on process conditions. For instance, a low melt viscosity may be beneficial when there is a need for the distribution and spreading of the elastomeric layer over a substrate such as a fibrous or felt layer during processing.

Surprisingly, a lower melt viscosity and the MAgPP itself allow the elastomeric layer to either interlock with fibrous materials and/or bind to polymer substrates with higher surface energy than polyolefins, such as polyester and polyamide.

The penetration and compatibility allows the elastomeric layer to improve properties such as peeling force from adjacent layers and/or temperature resistance. The increased crystallization temperature of the MAgPP may improve the temperature resistance of the elastomeric layer. This crystallization temperature of MAgPP occurs above 100 °C when compared with the crystallization temperature of the polyolefin elastomer alone, which occurs between 35 and 100 °C. This addresses one of the major problems of polyolefin-based elastomer layers, which may occur during climate aging cycles. With the lower crystallization temperature, the polyolefin alone is often unable to continue adhesion under climate aging conditions, which simulate extreme environmental conditions that may occur in a vehicle such as high temperatures or cycles between high and low temperature extremes.

The crystallization and melting temperatures of the MAgPP are chosen such that the range of testing conditions for climate aging tests are covered. Preferably, the crystallization and melting temperatures of the MAgPP are above 110 °C.

The crystallization and melting temperatures are measured by differential scanning calorimetry according to ISO 11357.

Preferably, the claimed elastomeric layer with MAgPP exhibits a peeling strength of at least 15 N/5 cm or failing cohesively, whereby the peeling failure occurs within the substrates adjacent to the interface and not at the interface itself.

The peeling strength is measured according to ASTM D-413-98, type B, 90° Peel, 23 °C, 55% relative humidity. The samples were preconditioned. The sample size was 200 by 50 mm steel punch was used to cut out the samples.

The elastomeric layer according to the invention comprises a thermoplastic polyolefin elastomer, an inorganic filler, a fatty acid, and a maleic-anhydride grafted polypropylene (MAgPP).

The thermoplastic polyolefin elastomer preferably comprises a mixture of thermoplastic polyolefins, for instance a first component comprising a partially amorphous polyolefin, preferably an amorphous poly-alpha-olefin APAO, and a second polyolefin component with another composition.

Preferably the second component may consist of a PP-Ethylene copolymer. Preferably the PP-ethylene copolymer has a random ethylene repeat distribution such that the specific density of the PP-Ethylene copolymer is less than 0.89 kg/dm³.

The elastomeric layer comprises an inorganic filler material, preferably comprising calcium carbonate or barium sulphate.

Preferably the filler material comprises between 20 and 80 percent of the elastomeric layer, allowing a balance between area weight and viscosity.

This may be beneficial, for instance, for optimal processability to spread, extrude, or inject over an adjacent layer. High percentages are still possible, though, if a high area weight for acoustics is needed.

In addition to the filler material, the elastomeric layer comprises an additional fatty acid. This fatty acid coats the filler and makes it compatible with the thermoplastic polyolefin material.

Surprisingly, the MAgPP does not negatively interfere with the function of the fatty acid.

The fatty acid may comprise at least fatty acids with an aliphatic chain of at least 14, preferably with an aliphatic chain of 16 and/or 18.

Preferably the fatty acid comprises between 0.2 and 3 percent by weight of the elastomeric layer.

Optional additives for the elastomeric layer include paraffinic oil, stabilizers, or antioxidants, which may include, but are not limited to, phenolic, amine, or phosphite-based compounds, for protecting the elastomeric material from degradation during processing and application.

Additional optional additives may comprise colorants, flame retardants, or other functional materials, to impart specific properties or characteristics to the elastomeric material as required.

By adjusting the percentages of the components within the given ranges, the area weight and viscosity of the elastomeric layer may be adjusted according to the specific application requirements and desired properties.

By altering the thickness or density of the layer, the area weight may be tailored to achieve optimal performance, durability, and functionality for a wider range of applications and requirements. This versatility allows the elastomeric material to be customized to meet the needs of diverse end-use scenarios, ensuring that the final product delivers the desired balance of properties and performance.

Surprisingly, by the use of MAgPP, the adaptation of the process details to achieve superior properties is simpler without the change of the entire recipe; the amount of MAgPP may be adjusted alone without changing the rest of the recipe, therefore maintaining the inherent qualities of the recipe.

The melt flow index (MFI) of the elastomeric material may be divided into two distinct preferred ranges, each catering to specific application requirements and desired properties.

High MFI range: This range is appropriate for elastomeric materials that necessitate a lower viscosity and improved flowability during processing. Materials with a high MFI are well-suited for applications that call for enhanced processability, ease of application, and the ability to form thin, uniform layers, for instance using a roller-coater or spray coating application process.

Preferably, in this case, the melt flow index (MFI) of the elastomeric layer comprising MAgPP according to ISO 1133-1 (2012) is between 100 and 400 g/10 min at 150 °C, more preferably between 150 and 300 g/10 min at 150 °C.

Preferably, the high MFI range comprises an area weight of the elastomeric layer between 100 and 1000 g/m^{2 .}

Surprisingly, the high MFI and the low area weight combinations, for instance, allow for much better controllability of application weight.

Low MFI range: This range is suitable for elastomeric materials that require a higher viscosity and greater resistance to flow during processing. Materials with a low MFI are ideal for applications that demand increased mechanical strength, durability, and resistance to deformation.

To maintain processability in the low MFI range, the MFI preferably ranges from 5 to 100 g/10 minutes at 190 °C, more preferably between 20 and 60 g/10 minutes at 190 °C.

Preferably, the low MFI range comprises an area weight of the elastomeric layer between 1001 and 5000g/m².

Surprisingly, despite the varying MFI ranges, the elastomeric material is capable of maintaining its desired characteristics and functionality across both low and high MFI ranges, demonstrating a remarkable level of versatility and adaptability for diverse applications and processing conditions.

Additional advantages may be further provided by higher crystallization temperature achieved by adding MAgPP, for instance during a melting and roller coating application process. Normally during this process, cooling rollers require special coatings to prevent the thermoplastic elastomer from sticking to the cooling roller. With the higher crystallization temperature achieved by the MAgPP, the thermoplastic elastomer sticks less to the cooling roller and may require less complex equipment.

Surprisingly, the higher crystallization temperature of the elastomeric layer with the MAgPP gives an additional advantage during the recycling of the material, as the thermoplastic elastomer does not melt and become sticky until higher temperatures. This allows the opening of a fibrous substrate comprising the elastomeric layer without molten elastomeric layer sticking to the pins of the machine opening the fibers. This facilitates improved recyclability of the offcuts or at the end of life.

The elastomeric layer is preferably produced in conjunction with at least one additional layer, although it may be produced on its own, the process conditions are such that producing it in conjunction with an additional layer gives a stronger bond. A second layer may be used in addition, on the side opposite from the first layer. The second layer may be added during the initial processing or later during additional steps.

The multilayer trim part for a vehicle, according to the invention, comprises at least an elastomeric layer and a first layer adjacent to and laminated surface to surface to the first layer.

The first layer and additional layers may be chosen from a broad range of materials or material combinations, for instance polyesters, polyamides, thermoplastic polyurethanes, cellulose-based materials such as cotton, cellulose or kenaf or protein-based materials such as wool fibers or mixtures of any of the above. Materials may derive from virgin, recycled, or reclaimed sources. Preferably the polyester is a terephthalate-based polyester, preferably polyethylene or polybutylene terephthalate. Preferably 10 to 50% of the fibers used are bicomponent binder fibers comprising a terephthalate-based polyester core and a lower-melting sheath such as a copolyester or a lower melting temperature polyolefin.

The first layer may be a fiber based material such as a woven, nonwoven, or knit, felt, textile, scrim, or a foam type material, or a foil or sheet type material or a combination of such material.

A fiber layer such as a nonwoven, scrim or felt may be for instance needled, tufted, thermal treated or air-laid. Fibers may be defined as staple fibers or endless filaments and may be processed to form yarns, textiles or random webs.

The layer or layers may also comprise mixed layers which are assembled and processed or molded to form product parts when used in combination with the elastomeric layer with MAgPP. They may comprise multiple fibrous, felt, scrim, or film layers, for instance as in a tufted carpet or a nonwoven carpet system. These systems which make up automotive trim parts may comprise for instance closed or open cell foam layers, or mixed layers combining foam and felt material, for instance a felt layer with foam chips or a scrapped waste material layer, or a film, foil or surface coating layer, for instance a filled or unfilled thermoplastic elastomeric layer. These layers may serve to enhance acoustic absorption, or improve mechanical properties such as tensile strength, abrasion resistance, or bending stiffness.

In a system such as that typically found in a tufted or nonwoven carpet, the improved compatibility and, preferably in lower MFI ranges, the low MFI may allow for the binding of carpet tufts or the binding of fibers in a nonwoven carpet, improving the abrasion resistance of the carpet. It may, however, be used in combination with additional tuft-binding layers for situations with high abrasion requirements.

In, for example, a floor system comprising an aesthetic thermoplastic layer, the improved compatibility may improve aging characteristics of the structure, preventing delamination of the thermoplastic layer in extreme climate conditions.

Advantageously, the addition of the MAgPP to the material acts to reduce interfacial dissimilarity between the thermoplastic polyolefin elastomer and adjacent layers, significantly improving the bonding to both smooth and fibrous surfaces and improving the interlocking between the polyolefin elastomer and the adjacent layer or layers, even if they are dissimilar materials which would normally require complex bonding processes and/or additional layers.

The addition of MAgPP in the elastomeric layer may provide additional advantages when the second layer in the trim part comprises a layer of back-injected polyurethane foam, removing the need for a primer or film for adhesion of the polyurethane to the elastomeric layer. However, a trim part comprising a film as a barrier between the MAgPP and a polyurethane foam is also considered. Typically, with TPO layers, a multilayer film is required with one polyolefin-based side for bonding to the TPO and one for instance polyamide or TPO-based side for adhesion to the polyurethane foam. These multilayer films may be replaced by a single, more film as a barrier layer in the case of MAgPP and polyurethane foam.

Optionally, in multilayer trim parts such as the ones claimed, additional stiffening elements such as foam spacer blocks or plastic pieces may be added to the layers, preferably between two other layers but may also be adjacent and bound to the elastomeric layer.

The improved compatibility of the elastomeric layer may, for example, allow for a foam spacer block made from a polymer or natural substance to be bound to an acoustic material, such as a fiber or felt layer, without requiring a complete encapsulation by other layers to hold it in place.

Additional elements may be added as are typically known in automotive trim parts such as clips or brackets.

A process for the application of the elastomeric layer with MAgPP, according to the invention, onto one or more additional layers may comprise the steps of thermal mixing and distributing the as such prepared elastomeric material onto at least one layer. Preferably the layers bonding is further enhanced by a calendaring or similar step to smooth and or form at least the elastomeric layer. Embossed rollers may be used to distribute the material in a pattern of uneven distribution over the surface and/or to create an embossed pattern on the surface of the thermoplastic layer.

In an alternative process the thermoplastic material is applied to a first layer and before final cooling a second layer in the form of a fibrous, film or foam layer is laid on top of the thermoplastic layer forming a sandwich with a thermoplastic core. All layers may be subject to a compressing step to obtain a more intimate bond between the layers.

The process step of mixing and application may be done by for instance, an extruder or other thermal mixer combined with, for instance, a roller-coater, slot die, spray, injection, or calendaring system.

The process may involve the step of dosing the MAgPP and optionally additional ingredients during the manufacturing process.

The elastomeric layer may be compounded in a first step whereby at least all a thermoplastic polyolefin elastomer, an inorganic filler, and a fatty acid are compounded. The as such compounded material may be pelletized and stored for later use or may be used in the compounded form immediately. Such a compounding step is preferably done under thermally adapted conditions.

In a preferably second step just before applying the thermoplastic material onto the at least first layer, the compounded elastomeric material is mixed with MAgPP and optional additives, for instance as pellets dosed and mixed with the elastomeric layer material as pellets, after which the two are melted and thermally mixed.

However, dosing and thermally mixing the MAgPP and optional other additives in a process step separate from the compounding of the material of the elastomeric layer may provide significant advantages to the flexibility of the process described, as the amount of MAgPP dosed may be tuned depending on the requirements of each trim part produced. And may be finetuned during the production process.

Other thermal mixing options for the compounding of the elastomeric layer material and the subsequent dosed addition of the MAgPP may include for instance internal mixers, two-roll mills, or extruders. Through the application of appropriate temperature, shear forces, and mechanical energy, a homogeneous mixture with the desired temperature and viscosity may be achieved. The choice of the appropriate processing conditions depends on factors such as the specific blend of ingredients in the elastomeric layer material, desired temperature and viscosity, scale of production, and specific processing requirements.

Processing of the material after melting and thermally mixing may include any distribution system which would either apply the elastomeric layer directly to another layer, or one which would process the elastomeric layer into an individual elastomeric layer sheet to be re-heated later and processed by, for instance, a moulding process, into a multilayer trim part.

Specific advantages are foreseen by the direct application of the elastomeric layer onto the at least one layer, including energy savings due to the lack of reheating and the ability to apply the elastomeric layer to another layer in a manner which gives, for instance, optimal fiber penetration and interlocking.

These methods also allow the elastomeric layer to be sandwiched between the at least one layer and an additional layer. For instance, the elastomeric layer might be melted and extruded as a sheet onto a first layer, whereby a second layer is added and the two are compressed together by a set of rollers.

Preferably, when fibrous layers are employed and it is possible within the limitations of the processing conditions, the thermoplastic elastomeric material penetrates and interlocks with the adjacent layer.

The dosing of the MAgPP may provide versatility to the elastomeric layer, allowing tuneable adhesion and viscosity ranges depending on the requirements of the substrate and the desired penetration depth of, for example, a fibrous substrate.

In all cases, a patterned, uneven, or grooved roller may be used to apply the elastomeric layer, resulting in alternative area weight distributions when, for example, local periodic higher area weight is required for additional bonding.

The elastomeric layer, either as a layered structure or as an elastomeric layer alone, may be cooled and stored as a roll good or cut into blanks for later production or made directly into an automotive trim part. The layers or blanks are preferably heated by contact oven or infrared before optional additional substrates such as fibers or felts are added to the multilayer structure before compression molding into the final trim part shape.

Use of an automotive trim part containing an elastomeric layer according to the invention as an acoustic layer in interior and exterior trim parts, for instance, trunk-side trim, interior cladding, inner dash, flooring parts, wheel arches, outer dashes, engine or electric motor covers or encapsulations, or battery covers.

The elastomeric layer may in addition be used as an intermediate layer, barrier layer, or aesthetic surface layer for automotive trim parts such as tufted or needlepunch carpets, trunk or frunk trim, or thermoplastic polyolefin-based aesthetic surfaces.

### BRIEF DESCRIPTION OF DRAWINGS

FIG. 1 shows a multilayer trim part of one embodiment of the invention.

FIG. 2 illustrates a cross-sectional view of a cut pile tufted carpet system designed for automotive applications.

FIG. 3 shows a schematic of a process of manufacturing a trim part of one embodiment of the present invention.

### DETAILED DESCRIPTION

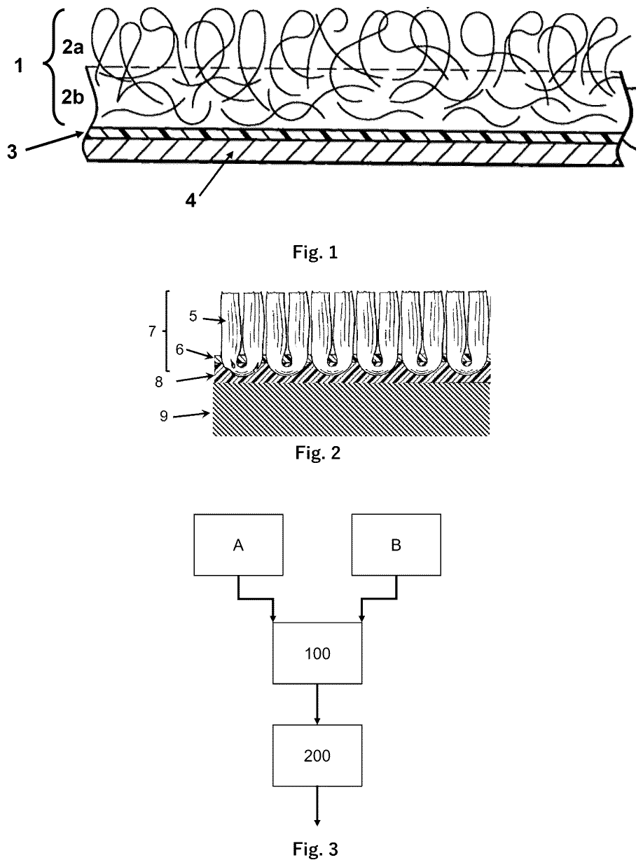

FIG. 1 shows a multilayer trim part according to the invention comprising a needle punch carpet layer (1), an intermediate elastomeric layer according to the invention (3), and a decoupler or backing layer which may comprise a felt or a foam. The elastomeric layer according to the invention is able to bind well to the back of the carpet layer as well as binding well to the decoupler layer, even if they are different or dissimilar materials. In this instance, the high-MFI range material would preferably be used to provide a strengthening layer to the carpet backing, preferably with an area weight between 150 and 500 g/m²

In carpet systems according to the invention, the pre-coat, secondary backing layer and the barrier layer of the state of the art as shown in FIG. 1 are replaced by one single layer, the elastomeric layer (3). This layer is surprisingly robust in abrasion and peeling force due to the addition of MAgPP to the elastomeric layer, which enhances the interfacial similarity and therefore adhesion of the two layers. Additionally, due to the higher melting crystalline portion of the MAgPP, the elastomeric layer is better able to withstand higher temperature ageing conditions.

The elastomeric layer is further bound to an additional layer (4) in this embodiment, comprising a felt material such as a polyethylene terephthalate fibrous layer bound with bicomponent fiber comprising a lower-melting copolyester sheath. The elastomeric layer effectively bridges the two layers, providing dimensional stability, adding stiffness to otherwise flexible layers, and improving the durability of the part.

FIG. 2 illustrates a cross-sectional view of a cut pile tufted carpet system designed for automotive applications. The carpet system comprises yarn tufts (5), which may comprise for example polyester and/or polyamide materials, depending on the desired properties and performance of the final carpet. These yarn tufts are inserted through a primary backing material (6) to create loops on the back surface, and a pile, which may be cut to achieve a cut pile surface (7).

Following the tufting process, the carpet is subjected to a secondary backing application, whereby a layer of elastomeric material according to the invention (8) is applied to the back of the primary backing material, effectively locking the tufts and fibers in place. The improved compatibility of the elastomeric material with the material of the more tufts and/or primary backing material, which may comprise a polyester such as PET or a polyamide, allows for a significant improvement in tuft binding.

Surprisingly, the thermoplastic polyolefin elastomeric material including MAgPP also improves tuft binding, improving the abrasion performance and the stiffness of the material, as well as the temperature resistance of the carpet, while simultaneously providing a binding surface for the decoupler layer (9).

The elastomeric layer is further bound to an additional decoupler layer (9) in this embodiment, comprising a back-injected polyurethane foam. The elastomeric layer comprising MAgPP may provide a surface which polyurethane foam is capable of adhering well to, reducing the need for a film or adhesion promoter. Nonetheless, a film, which may be reduced in complexity due to the reduced need for multilayer films, is optionally present for preventing bleed-through of the foam when required (not shown).

FIG. 3 shows a schematic for a process of manufacturing a trim part according to the claims, whereby in a first step (100), a first mixture A comprising at least thermoplastic polyolefin, filler, fatty acid, and additives and a second mixture B comprising at least MAgPP and optional other additives are added during a thermal mixing procedure. Mixture A may be pre-compounded thermally to provide a single dosing material, preferably in the form of pellets or granules. Mixture A and B may be combined immediately upon starting the blending process are there may be a delay in adding mixture B. Preferably the amount of mixture B can be adjusted to optimize the application and bonding to the at least one layer.

The blending of mixture A and B together may be performed for instance in a single screw extruder, which provides the thermal mixing forces and heat required for comprehensive blending.

In a second step (200), the blended mixture of A and B is applied to at least one layer to form the elastomeric layer according to the invention on top of the at least one layer. The application may be done by extrusion, injection, or coating, for instance a roller coating system, flat die extrusion system, or calendaring system. The thickness and/or the area weight of the applied layer may be adjusted depending on the requirements of the multilayer trim part. The application step may be combined with a compression of the layers. Optionally directly after application of the thermoplastic layer a second layer is placed on the top surface and all layers may be compressed to obtain a sandwich type construction.

The thus formed semifinished material either 2, 3 or multilayers, may be cut into blanks and stored for later use or may be subjected to at least one more step to form the multilayer trim part. This may include at least one or multiple process steps depending on the layering and the shape of the trim part. For instance, a thus formed 2-layer material from step 200 may be combined with a molding step comprising additional back foaming to obtain a 3 layer trim part able to attenuated sound. Additional steps therefore may include forming, molding, cutting or welding.

After the elastomeric layer is applied, the resulting structure may be made directly into a multilayer automotive trim part, or may be cooled and stored as a roll good or cut into blanks for later production into an automotive trim part. The layers or blanks may be reheated by contact oven or infrared before substrates such as fibers or felts are added to the multilayer and the thus formed stack of layers may be subjected to a forming step such as compression molding to produce the final trim part shape. The heating step may not be required, though if the adjacent layer is formed on the back of the thermoplastic layer, for instance back foaming a polyurethane foam, by a reaction injection foaming process, where the foam may be directly formed on the back of an elastomeric layer.

1. A multilayer trim part for a vehicle comprising:
at least a first layer and an elastomeric layer adjacent to and laminated surface to surface to the first layer; and
whereby the elastomeric layer comprises a thermoplastic polyolefin elastomer, an inorganic filler, and a fatty acid, wherein the elastomeric layer further comprises a maleic anhydride grafted polypropylene (MAgPP).

2. The multilayer trim part according to claim 1, whereby the MAgPP is between 5 and 30% by weight of the elastomeric layer.

3. The multilayer trim part according to claim 1, whereby the maleic anhydride grafted polypropylene has a melt viscosity between 2000 and 50000 mpa·s.

4. The multilayer trim part according to claim 1, whereby the maleic anhydride grafted polypropylene has a crystallization temperature above 100 °C, preferably above 110 °C.

5. The multilayer trim part according to claim 1, whereby a peeling force measured according to ASTM D-413-98 between the first layer and the elastomeric layer is either at least 15 N/5 cm or failing cohesively.

6. The multilayer trim part according to claim 1, whereby the thermoplastic polyolefin elastomer comprises a first component comprising an amorphous poly-alpha-olefin and a second component comprising a polypropylene-ethylene copolymer.

7. The multilayer trim part according to claim 1, whereby the filler comprises between 20 and 80% of the elastomeric layer.

8. The multilayer trim part according to claim 1, whereby the filler comprises calcium carbonate, barium sulphate, or mixtures thereof.

9. The multilayer trim part according to claim 1, whereby the fatty acid comprises between 0.1 and 2% of the elastomeric layer.

10. The multilayer trim part for a vehicle according to claim 1, whereby the elastomeric layer has a melt flow index at 150 °C of between 100 and 400 g/10 min.

11. The multilayer trim part for a vehicle according to claim 1, whereby the elastomeric layer has a melt flow index at 190 °C between 5 and 100 g/10 min,

12. The multilayer trim part for a vehicle according to claim 1, further comprising one or more additional layers, and whereby at least one layer is adjacent and at least partially bound to the elastomeric layer, and whereby at least one of the layers comprises a fibrous layer.

13. The multilayer trim part according to claim 1, whereby at least one or more layers comprises a fibrous material comprising polyester fibers and between 5 and 50% of a bicomponent copolyester fiber binder comprising a poly(ethylene terephthalate) core and a copolyester or polyolefin sheath with lower melting temperature than the core.
